(19) United States
(12) Patent Application Publication
(10) Pub. No.: US 2018/0160704 A1
(43) Pub. Date: Jun. 14, 2018

(54) PROTEIN-BASED DRY-EXPANDED FOOD PRODUCT AND METHOD FOR PRODUCING SAME

(71) Applicant: PROTEIFOOD S.A., Enghien (BE)

(72) Inventors: Jean-Jacques SNAPPE, Festubert (FR); Pierre OLIVIER, Bruxelles (BE)

(73) Assignee: PROTEIFOOD S.A., Enghien (BE)

(21) Appl. No.: 15/580,992

(22) PCT Filed: Jun. 9, 2016
(86) PCT No.: PCT/EP2016/063137

§ 371 Date: Dec. 8, 2017

(30) Foreign Application Priority Data
Jun. 12, 2015 (BE) 2015/5357

(51) Int. Cl. A23J 3/26; A23P 30/30; A23J 3/08; A23J 3/16; A23P 30/10

(52) U.S. Cl. CPC A23J 3/26; A23P 30/30; A23P 30/10; A23J 3/16; A23J 3/08

(57) ABSTRACT

The invention relates to a dry-expanded food product comprising at least the following ingredients: a food-grade protein concentrate made of animal or plant protein; a food-grade texturizer selected from the group consisting of plant-derived hydrocolloids and gelling agents, proteolytic additives and the hydrolysis products thereof, and acidifying agents and the salts thereof; and residual water. The invention also relates to a thermally expandable precursor able to shape this dry-expanded food product, as well as the corresponding preparation methods.

### FIELD OF THE INVENTION

The present invention relates to an expanded dry food product based on protein for food or feed and a method for its manufacture. More particularly, the invention relates to an expanded dry food product of biscuit, snowflake or wafer type, including a crispy nutritional product having low calories and good organoleptic properties, which can be eaten as such or mixed with an edible liquid such as milk or water. In particular, the invention relates to a food product of biscuit, snowflake or wafer type having a long shelf life, without cereal flour, but providing both the protein content (especially for nutritional products) and the minerals content, including calcium, magnesium, phosphorus and iron, necessary for children, adults, athletes and the elderly. The present invention also relates to an economical and efficient method for manufacturing such an expanded dry food product.

### BACKGROUND OF THE INVENTION

High-protein biscuits based, for example, on wheat flour, lupine flour, soy proteins, wheat gluten, and possibly acacia gum, baking powder, etc., are well known in the slimming diets for humans to allow fat burning and weight loss while preventing melting of muscle mass. In this context, we also know various cookies, cakes, pancakes made from whey protein. However, without an effective and flexible large scale manufacturing process, such cookies usually have a manufacturing cost, and therefore a selling price, too high for a large part of the population. Moreover, it is also widely recognized that in this type of dry food product intended for human consumption and after physical or athletic training, crispness is often achieved at the expense of the organoleptic properties.

Despite their potential interest to the sector biscuits, milk proteins, as isolates or concentrates, are still a small market for dietary products for human consumption, compared to production of fresh cheeses, yogurts, drinks, ice creams, sauces, infant formula, and animal feed.

Moreover, expanded dry biscuits are already known for feeding domestic animals such as dogs and cats, as well as horses.

In the literature, known expanded food products consist of ternary mixtures of carbohydrates, lipids and proteins. Their water content can be from 10 to 35% before expansion, and up to 10% after expansion. Expansion may be obtained by extrusion or by rapid heating by microwave of a gelatinized article, and can achieve a coefficient of 3 to 5.

It is also known to manufacture expanded dry cheesy product by subjecting an article of cheesy origin having a water content of 25 to 65% by weight to a drying/expansion treatment in a microwave oven, in vacuum, at a temperature of 400° C., until a water content of less than 10% by weight is reached, during 20 seconds to 10 minutes, to achieve an expansion coefficient of 2.5 to 4.0.

A crispy product, high in protein and low in fat, is also known, obtained from a mixture of 18-38% by weight of whey protein, soy, rice or peas, 5-30% of starch and 40-65% by weight of water, with an added preservative, by expanding the mixture under heating in a microwave oven. Also known is a cheesy product, expanded though heating by microwave, comprising 20-59% by weight of milk protein, from 10 to 50% by weight of starch, 2-24% by weight of an alcohol sugar (sorbitol, xylitol, mannitol or glycerol), and 3-15% by weight of water, wherein the fat content does not exceed 10% by weight. However, these products lack nutritional character because of the added amount of starch and sugar.

Also known is the preparation of granular slag produced and expanded by treatment with microwaves of a hard cheese powder having particle size 0.2 to 5 mm and a moisture content not exceeding 45% to obtain a moisture content of less than 15%. The product obtained is however limited by the gustative qualities and by the content in the originating cheese of fat. The product obtained is limited by the taste and fat content of the starting cheese.

Also known is a heat-expandable precursor for forming a synthetic cheese comprising (by weight) 12 to 26% milk protein, 7-30% starch and 46-60% water, said precursor comprising no more than 10% fat. After thermal expansion, this precursor forms a crusty synthetic cheese comprising (by weight) from 20 to 59% milk protein, 12-68% starch and 3-15% water, said synthetic cheese comprising no more than 22% fat.

There is therefore still a need, in the art of alimentary techniques, for dietetic protein-based crispy expanded food products, in particular crispy foodstuffs with very low starch and fat, providing a wide variety of possible flavors, savory or sweet, depending on the preferences of consumers. There is also a need in the art for crispy expanded food products based on protein of various origins, animal and/or plant, to adapt both to the availability of local agricultural resources and to the dietary preferences of consumers e.g. for vegetarian diets. There is also a need for a type of crunchy biscuits products for animal feed, including pets. There is also a need in the alimentary field for a method of making such crispy expanded products, which is economical and efficient and offers, at low cost, a large flexibility for different types of proteins useful as starting materials, depending on the organoleptic qualities of desired products and depending on the type of food, or feed aimed at.

### SUMMARY OF THE INVENTION

It has been surprisingly found that the needs expressed above in human and animal food technology, as well as dietary problems mentioned above could be solved advantageously by means of:
an improved composition of matter of expanded dry food product as defined in claim 1 in its broadest expression, and in each of claims 2 to 11 regarding the particular embodiments;
a composition of matter of a thermally expandable precursor capable of forming said expanded dry food product as defined by claims 12 and 13,
a process for preparing a thermally expandable food precursor as defined by claim 14, and
a method of manufacture of dry expanded food product as defined by claim 15.

### DETAILED DESCRIPTION OF THE INVENTION

A first aspect of the invention therefore relates to a dry expanded food product comprising at least the following ingredients:
a protein concentrate of animal or vegetable origin, food-grade,
a food-grade texturizing additive selected from the group consisting of hydrocolloids and vegetable gelling agents, proteolytic additives and their hydrolysis products, and the acidifying agents and salts thereof, and
residual water.

Optionally, the expanded dry food product according to the invention may comprise:
food-grade added fat,
a food-grade salt derived from an inorganic or organic acidifying agent, but preferably other than a phosphate or citrate, and/or
a proteolytic additive, or its hydrolysis product.

Protein concentrate of animal origin” means any source other than human or plant. So it could be a concentrate from insects.

“Dry product” within the present invention means a product whose residual water content enables to keep intact the original taste and organoleptic properties for a period of several months, preferably a period of 2-30 months without the need to store the product in usual refrigeration conditions of food (about below 5° C.). This property of keeping intact the original taste and organoleptic properties generally corresponds to a residual water content of less than 12% by weight, for example less than about 10% by weight, for example not exceeding 9% by weight, or about 8% by weight, but more often to at least 3% by weight, for example at least 4%, at least 5%, at least 6%, or at least 7% by weight. The skilled person knows that it is not desirable, both from the standpoint of the increasing manufacturing costs of related to the removal of water, and from the standpoint of preservation of the product for a prolonged storage period (even under ideal conditions of temperature and humidity, see below), to reduce the residual water content in the food product to below 3% by weight. Inversely, with a residual content of greater than 12% water by weight, it is no longer possible, as a rule, to characterize the food product as a dry product. Clearly, whatever the nature of the packaging in which it is packaged, and despite a residual water content thus selected, the proper conservation of the expanded dry product according to the invention in time cannot be guaranteed if the product is permanently maintained at a temperature above 25° C. It is of course always advisable to store the dry expanded product, regardless of the packaging used for its packaging, in a cool, dry place, that is in a room with air conditioning maintained between about 10° C. and 20° C. on average and at a controlled level of humidity.

“Expanded product” under the present invention means a honeycombed product with air-filled cells representing at least 50% of the volume of the product, optionally at least 65% by volume, or at least 80% of the volume and even up to 85% by volume. This expanded structure gives the product, according to the invention, a crispness appreciated by consumers and which can be quantified, if necessary, especially by measuring the breaking force (in N), well known in the art.

The expanded dry product of the first aspect of the invention is not a traditional bakery product, mainly based on cereal flour (70% by weight of wheat flour in the case of crackers commercially available) and thus containing large amounts of starch inherent to such a flour. Its composition includes essential ingredients, all food-grade, as specified above and in each of the appended claims. By “essential ingredients” it is referred to the ingredients representing together at least about 96% of the product weight, preferably at least 98% of the product weight, and even more preferably at least 99% of the product weight. These proportions are understood relatively to the crude expanded dry product, that is to say before the application of any coating or food topping on its surface. The complement to 100% by weight is made, if any, of optional ingredients such as sweeteners, coloring agent, flavorings as detailed below.

“Food-grade” means, for each ingredient, a satisfactory quality under national and international standards in health matters for human or animal consumption, concerning, in particular, the purity of the ingredients and their non-contamination by physical, chemicals or potentially dangerous biological agents.

As for the traditional industrial biscuit products (savory and sweet), the expanded dry product according to the invention may, for commercial purposes related to its appearance and taste of the consumer, be covered, coated or topped with one or more food-grade coating layers, such that its dietetic, taste and organoleptic qualities are not altered.

By “protein concentrate” usable for the expanded dry product and the manufacturing method according to the invention, it is referred to a raw material very predominantly, or essentially consisting of naturally occurring proteins (animal or plant), and thus free of the main unazotized constituents usually encountered in cereal flour (about 70% by weight starch in wheat flour) or animal meal. The “protein concentrate” present in the expanded dry food product according to the invention is thus a preparation extracted from a natural raw material (plant or animal), and wherein the non-protein components have been essentially eliminated , using one or more well-known techniques such as fractionation, precipitation, extraction, separation, isolation, purification, etc. These non-protein components can be a food-grade fat. This should not be confused with the food grade added fat which may be an optional ingredient in a particular embodiment of the invention. Depending on the weight content of protein relative to the dry matter of the protein concentrate, and therefore depending on the method for obtaining of the protein concentrate, the term “protein concentrate” is understood to include also “protein isolates” having a protein content by weight (relative to dry matter) of at least 85% by weight. To the extent of their commercial availability, the preferred protein concentrates or protein isolates are substantially anhydrous or have a controlled and reduced water residual content.

Many naturally occurring protein concentrates (animal or vegetable) suitable as ingredients for the expanded dry product and for the process according to the invention are commercially available. Protein concentrates of animal origin include milk protein concentrates such as extracts of cow's milk, goat's milk, horse's milk , buffalo's milk, sheep's milk, etc. Their composition is detailed below regarding an embodiment of the present invention.

The base composition of the expanded dry food product according to the first aspect of the invention described above includes essential ingredients, including one or more a texturing additive (as define hereafter). Preferably the dry expanded foodstuff according to the first aspect of the invention is free of starch, native or modified.

The basic composition of the expanded food product according to the invention may in particular comprise at least one animal protein concentrate (for example dairy or fish) or vegetable. Milk protein concentrates include those containing caseins, serum or soluble proteins, and/or extracts thereof (eg, beta-lactoglobulin, alpha-lactalbumin, immunoglobulins, lactoferrin, etc.). For details about the possible components of a milk protein concentrate, reference to the article by JJ Snappe et alia, entitled “Protéines laitières” published in Dossier Techniques de I'Ingénieur(June 2010).

Other animal protein concentrates that may be mentioned are concentrated extracts of fishflours, of which there are many commercial examples, or earthworm (Eisenia foetida).

Protein concentrates of vegetable origin include, but are not limited to, concentrates of vegetable proteins such as proteins from leguminous plants (soybean, peas, lupins, lentils, broadbeans, beans), cereals (wheat, oats, corn, millet, barley, rye, buckwheat, rice, spelt, sesame), oil seeds (gourd, flax, peanut, pumpkin) or nuts (almonds, peanuts, pistachios, hazelnuts, walnuts), or extracts thereof.

Native protein concentrates from insects include, but are not limited to, commercial concentrated proteinextracts of insect flours such as, but not limited to, grasshoppers flour, weevils, caterpillars, worms silk, locust (Locusta migrator and Gryilus bimaculatus).

Given the variety of usable protein concentrates for the process and the expanded dry food product according to the invention, it is easy to adapt the production to the local availability while providing the full range of expanded dry food products depending on the characteristics of the local market.

The protein content of the animal protein concentrate (for example dairy or fish) or of the vegetable protein concentrate is very high, above 65% by weight, preferably greater than 75% by weight, preferably greater than 80% by weight, and even, in the case of protein isolates, greater than 85% by weight. The complement to 100% by weight usually consists of water (preferably at most about 5% by weight) and other components, which may have a nutritional value (for example, mineral salts such as those of calcium, carbohydrates, vitamins, fat) in proportions not detrimental to food quality or to the taste, dietary and/or organoleptic qualities of the expanded dry food products according to the invention.

The physical form of protein concentrate usable for the method and the expanded dry product according to the invention is not a particularly limitative feature of the present invention; however, a powder form with controlled and even particle size is obviously preferable, in particular for the miscibility with the other main ingredients. Particle sizes ranges desirable for implementation of the invention depend on the source of protein used and the commercial availability, but are generally comprised between about 30 and 200 μm, preferably between 50 and 150 μm, according to the origin of the protein concentrate, animal (eg. dairy or fish) or vegetable.

According to a first embodiment, the expanded dry food product of the first aspect of the invention is free of food grade fat, other than a residual non-protein component of animal or vegetable protein concentrate of food grade quality, i.e. contains no deliberately added food grade fat. Preferably the expanded dry food product according to this first embodiment of the invention is free of starch, native or modified.

According to a second embodiment, the usable base composition for expanded dry food product and the method according to the invention comprises, as essential starting ingredient, food grade fat. A fat, capable of being easily emulsified with at least a portion, preferably most or all, of the animal (for example dairy or fish) or vegetable protein concentrate is preferred. As fat, we can use, but not limited to, anhydrous milk fat, butter, liquid or powder cream or vegetable food-grade fat or, subject to miscibility, a mixture thereof. According to a particular embodiment of the present invention, a fat permitting, in an appropriate amount, to obtain an oil-in-water emulsion in the presence of the protein concentrate of animal or vegetable origin, is preferred.

Conventionally, anhydrous milk fat refers to the product obtained by separation from the cream or butter, followed by dehydration, without adding additives. The usable anhydrous milk fat therefore usually has a maximum moisture content of 0.1% by weight, a maximum of 0.5% by weight of fat-soluble compounds and a maximum oleic acidity of 0.3%. It may be manufactured from butter or cream after mechanical and/or thermal action, centrifugation and vacuum drying. One can also use a particular fraction of anhydrous milk fat obtained for example by fractional crystallization.

As vegetable food-grade fat, one may use preferably a vegetable fat having a melting point of at least 25° C. , such as for example a melting point of about 30° C. to 40° C. Non-limiting examples include margarines, hydrogenated or non-hydrogenated, based on coconut, palm, rapeseed, soybean, sunflower or other common plant species.

The physical form of the fat used is not particularly limited, however characteristics providing good miscibility, in the presence of water, with the animal or vegetable protein concentrate are advantageous from the viewpoint of the production of an expanded dry food product according to the invention, particularly from the standpoint of the efficiency through the first stage of its manufacturing process. For example, but without limitation, in one embodiment with a milk protein concentrate, one can choose to use an anhydrous milk fat or vegetable food-grade fat, or a mixture of both.

Preferably, the expanded dry food product according to this second embodiment of the invention is free of starch, native or modified.

According to the first embodiment of the invention described above, the proportions of water and concentrate protein of animal (for example dairy or fish) or vegetable origin in the base composition (including the precursor thermoplastic expandable) for the expanded dry food product of the invention may vary within wide limits but can be readily determined by the person skilled in the art, according to technical parameters such as the choice of animal or vegetable protein, its content in the concentrated protein, the desired dietary and nutritional properties of the final food product, its expansion capacity and the desired crispness, and economic parameters such as the duration of the manufacturing process and cost. In particular, it is usually desirable to provide, in the expanded dry food product of this first embodiment of the invention, about 60% to 95% by weight, for example about 65% to 90% by weight, for example about 70% to 85% by weight, for example about 75% to 80% by weight, of the protein concentrate of animal or vegetable origin.

According to the second embodiment described above, the proportions of water, fat and protein concentrate of animal (for example milk or fish) or vegetable origin in the base composition (including thermally expandable precursor) for the expanded dry food product of the invention and the initial step of the process according to the invention may vary within wide limits but can be readily determined by a person skilled in the art, according to technical parameters such as the choice of the fat, choice of animal or vegetable protein and protein content in the protein concentrate, the desired dietary and nutritional properties of the final food product, the expansion capacity and the desired crispness, and economic parameters such that the duration of the manufacturing process (particularly the maturation step) and the cost. These proportions are adjusted by the person skilled in the art so as to easily make, in the initial stage of production, the emulsion of the fat with a portion, preferably all, of the proteins, as well as the hydration of the animal (for example dairy or fish) or vegetable protein concentrate, while appropriately adjusting the viscosity of the mixture for the next steps. For this purpose, it is generally preferable that the weight ratio protein concentrate/water is between about ¼ and 1/1, preferably between ⅓ and ½ approximately. Similarly, the weight ratio of food-grade fat to water is an important factor of the invention, and it is generally preferred that this weight ratio fat water is between about ⅕ and ⅓, preferably between ¼ and ⅕, in the precursor before expansion/dehydration. This generally corresponds to a weight ratio of food-grade fat to water of 5/1 to 3/1 in the expanded dry product. To meet the goal of a dietary crunchy food product, the proportion of fat in the base composition usable for expanded dry product and the initial step of the process according to the invention must be kept as low as possible. Depending on the selected fat (origin, melting point, hydrogenated or not), and of the selected animal (for example dairy or fish) or vegetable protein concentrate, the skilled person knows how to determine, empirically, and using a limited number of preliminary tests, the proportions of water, fat and protein concentrate best suited to perform the initial step of the method according to the invention, without difficulty while ensuring the dietary and nutritional status of the final expanded dry product.

The composition usable for the expanded dry food product and the method of production according to the first and second embodiments of the invention comprises adding at least one texturizing agent or additive such as a hydrocolloid a thickener, an emulsifier, a gelling agent, a proteolytic additive or its hydrolysis product, an acidifying agent or a salt thereof. Preferably a hydrocolloid, other than gelatin is chosen. Non-limiting examples of suitable texturizing agent are vegetable agents such as alginic acid; alginates of sodium, potassium, ammonium, calcium and propylene glycol; carrageenan (kappa and iota); gums of carob, oats, guar; arabic gum, tragacanth gum, xanthan gum, karaya gum, tarn gum, gellan gum, ghatti gum, mannitol, and sodium carboxymethylcellulose, or a mixture of several of them. The type of texturizing agent (e.g. hydrocolloid) added depends, as known to the art, of the desired increase in the viscosity and of the desired type of texture for the final expanded dry food product. The proportion of texturizing agent (e.g. hydrocolloid) added is an amount sufficient to achieve the desired texturizing effect for the final expanded product, depending on the chosen type of texturizing agent. It is usually between about 0.3% and about 10% by weight, preferably between 0.4% and 4% by weight of expanded dry food product of the invention.

The composition useful for expanded dry food product according to the first aspect of the invention may comprise at least one proteolytic agent, or a hydrolysis product thereof, for cutting at least a portion, preferably a majority or all of the proteins present in the protein concentrate into smaller protein fragments, this cut being effective to modify the texture. A preferred proteolytic agent is an enzyme of animal, plant or microbial origin, of the class of the proteases, especially exo- and endopeptidases whose cut-off involves the use of a water molecule, or exopeptidases. The choice of this proteolytic agent, and of its effective amount, depends, as is well known in the art, of the proteins present in the used protein concentrate. According to a particular embodiment of the invention, when the food-grade protein concentrate is a concentrate of milk protein, an appropriate proteolytic additive consists of rennet or of a natural protease (endopeptidase) extracted from rennet, such as chymosin. Pure synthetic chymosin, obtained by fermentation of a genetically modified organism (eg. A fungus such as Aspergillus Niger), may also be used. Other suitable proteolytic additives may be on the one hand pepsin and, on another hand, active enzymes of vegetable origin such as cyprosine and cardosin. The effective amount of proteolytic agent, or one of its hydrolysis products, is usually very small, of the order of 20 to 200 ppm, and this agent is therefore found in trace amounts in the expanded dry food product of the invention.

The composition useful for expanded dry food product according to the first aspect of the invention may further comprise at least one salt of acidifying agent, or a precursor thereof, preferably other than citrate or phosphate. The acidifying agent in question can be a strong or weak acid (as defined by its pKa, well known to those skilled in the art), mineral or organic. By way of non-limiting example, one may mentioned sulfuric acid, gluconic acid, etc. The salt or precursor of acidifying agent must be of acceptable quality for human or animal consumption. An acidifying agent salt usable, especially where the food-grade protein concentrate is a soy protein concentrate, is calcium sulfate. (calcium salt of sulfuric acid). An acidifying agent salt usable, especially where the food grade protein concentrate is a concentrate of milk protein, is a gluconate or a food additive precursor such as glucono delta-lactone (E575 additive). A lactic ferment or other living organism capable of acidifying the medium is also usable. An appropriate amount of salt of acidifying agent, or precursor thereof, is a necessary and sufficient quantity to conduct the acidification of the medium during the cut of at least a portion t, preferably a major portion or the all, of the proteins present in the protein concentrate into smaller proteins fragments. Each additive may thus participate in the coagulation of the mixture in acid medium, for example by destabilizing the proteins, particularly the caseins. A preferred amount of salt derived from an acidifying agent, other than a citrate or a phosphate, or precursor thereof, is usually between 0.2% and 6% by weight, for example between 0.5% and 4% by weight of expanded dry food product.

The composition of the expanded dry food product according to the invention may further comprise one or more auxiliary additives of manufacturing as defined below, to provide the product with desirable nutritional properties.

An expanded dry product according to the invention, not comprising food-grade salt derivative of an acidifying agent, and/or proteolytic additive or hydrolysis product thereof, also has a very good expansion capacity but a less pronounced crispness.

For the manufacture of an expanded dry food product according to the invention, it is generally useful, but not necessary, to have a thermally expandable precursor capable of forming the final product by mere expansion under heating with reduction of the water content, for example by treatment with microwaves, or other appropriate treatment well-known in the food industry. Such thermally expandable precursor is thus another aspect of the invention, and it comprises at least the following ingredients:
a protein concentrate of animal or vegetable origin, food-grade;
a food-grade texturizing additive selected from the group consisting of hydrocolloids and vegetable gelling agents, proteolytic additives and their hydrolysis products, and the acidifying agents and their salts thereof, provided that the starch, preferably modified, represents less than 5% by weight of the precursor, and
water.

When for the manufacture of dry expanded food product according to the second embodiment of the invention, the thermally expandable precursor further comprises a food grade fat such as described above. The thermally expandable precursor according to the invention may further comprise a food-grade salt derivative of an acidifying agent, preferably other than a citrate or phosphate, and/or a proteolytic additive or a hydrolysis product thereof. Each of the ingredients of this precursor can be of the nature and amount as defined above about the expanded dry food product. Since the heat treatment of the thermally expandable precursor will have the effect, simultaneously with the expansion of volume, to reduce the water content to the level of a residual content compatible with the long term storage requirements at room temperature (about 15° C. to 25° C.), it goes without saying that the water content in the composition of the thermally expandable precursor according to the invention exceeds the water content in the final expanded dry food product, meaning it significantly exceeds 10% or 12% by weight. An appropriate water content in the composition of the thermally expandable precursor according to the invention depends on the number and respective proportions of the other essential ingredients and, where appropriate, the presence of optional ingredients such as food-grade salt derivative of an acidifying agent, and/or the proteolytic additive or its hydrolysis product. It also depends on the conditions of viscosity to achieve for easy handling of the mixture depending on the temperature conditions selected for the preparation process (see below). The series of examples provided below demonstrates that an appropriate water content in the composition of the thermally expandable precursor according to the invention is generally within a range of 65% à to 85% by weight of all the ingredients taken together for the first embodiment of the expanded food product (fat free), and 50%>85% by weight of all the ingredients together in the second embodiment of the expanded food product (with fat).

A process for preparing the thermally-expandable precursor of an expanded food product according to the second embodiment of the invention comprises the steps of:
combining, at a temperature between 4° C. and 60° C., the protein concentrate of animal or vegetable origin, the food-grade fat, the food-grade texturizing additive and water, and
subjecting the resulting mixture to a heat treatment at a temperature ranging between 65° C. and 140° C.

A process for preparing the thermally-expandable precursor of an expanded food product according to the first embodiment of the invention comprises the step of combining at a temperature between 4° C. and 75° C., the protein concentrate of animal or plant origin, the food grade texturizing additive and water.

If necessary, the process for preparing the thermally-expandable precursor of an expanded food product according to the first or second embodiment of the invention may comprise at least one additional step consisting in adding to the mixture resulting from the main step of combining the protein concentrate of animal or vegetable protein, the food grade texturing additive and water, a food grade salt derivative of an acidifying agent, preferably other than citrate or phosphate, and/or a proteolytic additive or a hydrolysis product thereof. The skilled person knows how to determine, by simple routine tests, both the type of device in which some initial combination (including contingent stirring means) and, if necessary, the appropriate time for the addition of the optional ingredients, in particular according to their thermal stability and their reactivity with the essential ingredients.

Finally, another aspect of the invention relates to a method of producing an expanded dry food product as defined in the first place, comprising the steps of the process for preparing the thermally expandable precursor, and further comprising the step of subjecting the thermally expandable precursor to heat, for example by means of microwaves, to cause its expansion to the desired degree of expansion, and reducing the water content to the desired residual content.

The process definitions above only include the essential steps for the fulfillment of the purpose of the invention. It is obvious to the skilled person that optional intermediate steps, such as maturation, molding, unmolding, grinding, grating, partial dehydration, may be added to facilitate the process leading to the final expanded product in the desired form, especially by giving it a desirable texture. Below is exposed, non-limitatively, a specific embodiment of a manufacturing method of an expanded dry food product according to the second embodiment of the invention, comprising such intermediate steps. This method comprises, only illustratively, at least the following steps:
(a) mixing to homogeneity a base composition comprising as essential ingredients water, food-grade fat, at least one food-grade protein concentrate of animal or vegetable origin, and at least one food-grade texturizing additive selected from hydrocolloids and plant gelling agents and , optionally, as optional ingredients a food-grade salt derivative of an acidifying agent, other than a citrate or phosphate, and/or a proteolytic additive or hydrolysis product thereof;
(b) subjecting the homogeneous mixture obtained in step (a) to a heat treatment by heating to a temperature between 65° C. and 140° C., followed by cooling to a temperature not exceeding 50° C. maximum;
(c) optionally adding, during or after the cooling of step (b), at least a proteolytic additive or a hydrolysis product thereof and at least one acidifying agent or a precursor or a salt thereof, and homogenizing the resulting mixture;
(d) pouring the homogeneous mixture obtained in step (c) into a mold;
(e) allowing the homogeneous mixture totexturize in the mold at a temperature between 5° C. and 65° C. for a time sufficient to proceed to its texturizing;
(f) optionally grinding or grating, optionally after a partial dehydration to reduce its water content to a value between 25% and 40% by weight, the coagulated mixture obtained in step (e) to adjust its particle size within a predetermined range, and
(g) subjecting the mixture, optionally ground or grated, and optionally partially dehydrated, obtained in step (e) or step (f) to a microwave treatment to proceed to its expansion and dehydration, to obtain said expanded dry food product with the required expansion ratio and residual water content.

Step (a) of the process of the invention consists in homogenizing the components of the base composition. This is done, preferably in a solid-liquid emulsifying mixer well known in the food industry, at a sufficient temperature and providing sufficient stirring, for homogenization to be achieved in minimum time. By way of non-limitative example of equipment used for steps (a), (b) and (C) of the process according to the present invention, one may mentioned in particular mixers-cookers jacketed for heating and cooling, and with direct steam injection such as universal machines UMSK marketed by the department Stephan of the company Sympak Process Engineering GmbH (Schwarzenbek, Germany). The choice of the type of equipment (form of material flow deflector, type of rotor-stator tool, etc.) and of the operating parameters (rotational direction and counter-rotation, stirring speed, etc.) of the solid-liquid emulsifying mixer is within the reach of the person of the art, using a limited number of preliminary tests, once the proportions of water, fat and animal or vegetable protein concentrate in base composition are known. It is preferable that the stirring speed in the solid-liquid mixer is between about 500 and 2000 rpm, preferably between 800 and 1500 rpm, If using devices of the rotor/stator type, the speed equivalencies data will preferably be shear rates between 5000 and 20,000 s⁻¹, more preferably between 5,000 and 10,000 s^{-1, eg} 7500 s⁻¹ approximately. Similarly, it is preferred that the content of the solid-liquid mixer is maintained at a temperature between about 4° C. and 60°, preferably between about 45° C. and 60° C. The temperature can be controlled by means of a probe, and can be kept constant throughout step (a), or can be programmed in a variable cycle if necessary. Depending on the settings (eg temperature and stirring speed) selected for the operation of the solid-liquid mixer, and the mass of composition to be homogenized, the duration of step (a) is usually between about 5 and 30 minutes, preferably between 10 and about 20 minutes.

At the end of step (a) of the process according to the invention, an homogeneous mass is obtained (for example pasty or liquid viscous) likely to contain many air bubbles. For the further steps of the process according to the invention, it is preferable to perform deaeration of this mass. This is accomplished by any suitable means, preferably by means of placing the equipment containing homogeneous mass under vacuum towards the end of step (a). Preferably, it is avoided to place the equipment under vacuum at the beginning of step (a) in order to avoid sucking a part of the protein concentrate powder. Preferably a vacuum of 0.1 to 0.9 bar is maintained. After this step, we obtain a smooth, homogeneous and deaerated mass.

In a second step (b), the homogeneous and preferably deaerated mixture obtained in step (a) is subjected to a heat treatment. A preferred temperature range for the heat treatment is from 65° C. to 140° C., preferably 65° C. to 90° C. Towards the end of step (b), the temperature of the homogeneous mixture, optionally deaerated, is allowed to decrease to about 60° C. maximum, e.g. 45° C. or even 30°, either naturally by heat exchange with the surrounding environment, or by active means of suitable cooling, such that cooling fluid circulation, ventilation, etc. Advantageously, step (b) can be accomplished in the same equipment, of the mixer-cooker type (eg a Stephan aforementioned equipment manufacturer) as that of step (a), using appropriate means of heating and cooling thereof.

During the next step (c), one may add other optional ingredients of the food product according to the invention, namely at least one proteolytic additive or its hydrolysis product and/or a salt of an acidifying agent or a precursor thereof. The chemical nature and the added amount of these additives has been detailed above. In that same step (c), one may also add, if necessary, a further amount of at least one of the essential ingredients of the food product in accordance with the present invention. Advantageously step (c) can be performed in the same mixer-cooker type of equipment (eg. A Stephan aforementioned equipment manufacturer) as that of step (a).

During step (a) and/or step (c), one may also add one or more auxiliary additives useful to improve a set of desirable properties, gustatory and or nutritional, of final expanded dry product These properties include in particular the shelf life, flavor, color, crispness, richness in fiber, etc. The auxiliary additives of manufacture useful for this purpose fall into categories of additives well known to those skilled in the art. These additives are normally added in very small proportions, generally less than 1% by weight for each of them, with the exception of the fibers, for which the proportion can advantageously reach about 4% of the final product, depending on the desired texture and nutritional quality.

For example, one can add one or more flavoring agents selected according to the taste to assign to the final expanded dry food product. For salty diet biscuits, one can add flavors, seasonings or spices according to the use, for example paprika, pepper, cloves, etc. For sweet diet biscuits, one can add natural or synthetic flavors such as vanilla, cinnamon, strawberry, raspberry, orange, pear, apple, etc. Depending on their nature, and depending on the intensity of the desired taste, the proportion by weight of the flavoring agent may be between 0.2% and 1% by weight.

One may also add at least one food-grade fiber, soluble or insoluble. In order not to affect the production process or the other desired qualities of the final expanded dry product, soluble fibers are preferred.

One can also add at least one non acidifying salt such as a halide, for example a chloride and/or iodide of sodium, which can have, depending on the amount added, different functions: improving the conservation, improving of swelling in the later stage, modifying the taste, etc. The same proportions by weight as above apply to the addition of non-acidifying salt. For dietary reasons, the proportion of salt should be as small as possible, unless the expanded dry products are crackers known for their saltiness.

During step (c), one may also add one or more acceptable colorants for food or feed. Preferably, auxiliary additives of manufacturing are added in powder form so as to easily mix with the deaerated homogeneous mass of the base composition.

During step (c), one may also add, in the case where it is desired to obtain finished products with a sweet taste, one or more natural sweeteners (such as sucrose or fructose) or synthetic sweeteners (such as aspartame or acesulfame) in sufficient quantity well known to those skilled in the art to provide the desired sweetness level.

During step (d) of the process according to the present invention, optionally, the mixture obtained from the mixing equipment (for example a mixer-cooker as described above) is poured into a mold, or any other solid support, of variable shape and dimension, in which will take place in the maturation step (e).

Step (e) of the process according to the present invention, during which, if necessary, the optional component(s) added to the step (c) is allowed to act on the homogeneous mixture (texturing or, as appropriate, acidification and coagulation) may be performed for a short duration (e.g. from 5 to 120 minutes) or a relatively long duration of a few hours (e.g. 2 to 24 hours) and at a temperature avoiding the denaturation of proteins or protein fragments present in the mixture. This maximum temperature not to be exceeded depends, as known in the art, on the proteins (animal or plant) in question. For an efficient production yield, and therefore to avoid an excessive length of the maturation, the optional step (c) is performed at a minimum temperature of 5° C., preferably at least at 15° C. The choice of the temperature of step (e) therefore results from a compromise between performance and the need to prevent inappropriate denaturation which would weaken the nutritional quality of the final food product.

The optional step (f) of the process according to the present invention follows, during which one makes an adjustment, preferably a reduction of the average size of the solid particles resulting from the texturizing/dehydration and, if necessary, to a partial dehydration of the homogeneous mass with additives. In this step, the water content of the homogeneous mass with additives can be significantly reduced to a level between about 25% and 40% by weight, preferably between 28% and 35% by weight. The partial dehydration at this stage is optional, given that it can also be carried out fully at the final stage, subject to the availability of a suitable equipment for microwave treatment. On the other hand, the average solid particle size is reduced by any suitable mechanical means such as grinding or grating, to an average size of between about 50 μm and 2 mm, preferably between about 100 μm and 1 mm. The shape of the particles obtained after step (f) is not a critical parameter of the present invention. The term “particle” does not imply a particular geometric shape. In the context of the method according to the invention, any shape, spherical or not, elongated or not (e.g., strands), may be suitable provided it can be expanded to a sufficient coefficient in the subsequent step (g). In a particular embodiment of the present invention, the type of size reduction operated also aims to reduce the dispersity of the particle sizes, that is to say to obtain a population of particle sizes as homogeneous as possible. This step (f) may be important in the sense that the behavior of the material in the subsequent step of microwave treatment was found to be largely dependent on parameters such as the residual water content, the average size of solid particles, and the dispersion of their sizes.

Finally, the final step leading to the expanded dry food product (type biscuit or flake) consists in subjecting the paste, dehydrated or not, grinded or not, obtained in step (f) to a heat treatment such as by microwaves. This treatment generally has the effect of further lowering the water content in the final product, to a value which may be comprised between about 3% and 12% by weight, for example between about 5%>10%) in weight, or between about 6% and 9% by weight, consistent with the requirements for long term storage, while performing expansion of the dough according to an expansion ratio (by volume) of about 1.5 to 6.0, for example about 2.0 to 3.5. The parameters of this treatment by microwaves, such as duration, power, wavelength, etc., can be easily adjusted by the skilled person, depending on the water content, the average size and dispersion of sizes of the particles of the protein material, as well as the shape and volume of the finished products, etc. Without limitation, this includes the following parameters:
a wave frequency varying in the usual range of commercial microwave equipment,
a power varying in a range between 200 W and about 1000 W,
a duration varying in a range comprised between 10 and about 120 seconds, preferably between 20 and about 100 seconds.

A dry and crispy food product is obtained at the end of this stage, ready to be transported by conveyor belt to a packaging system for bulk or sub-unit assemblies. If necessary, after step (g), a statistical quality control system may be implemented, for example a system comprising measuring the crispness such as for example the measurement of the breaking force (in N) in order to remove the products not meeting the standard set.

The following examples are provided purely for explanatory and illustrative purpose of the present invention and should not be construed as limiting the scope. These examples can be modified by adjusting one or more operational parameters (temperature, duration, dimensions) within numerical ranges mentioned in either of the preceding paragraphs.

### EXAMPLE 1

In this example, the equipment used is a Thermomix of Vorwerk brand with a capacity of 1.5 L. To make the base, 17,89 g standard anhydrous milk fat (provider: Corman SA, Belgium) are melted in 131 ml of spring water by heating to 50 ° C. and under gentle stirring (Thermomix in position 1) for 5 minutes. Then, a powder mixture, containing 50,23 g of protein Promilk SH20 (provider: Ingrédia, Arras, France) and 2,10 g of powder iota carrageenan (Textura brand Albert provider there Ferran Adria Barcelona, Spain) was added under gentle stirring (position 1 of the Thermomix). The mixture is maintained at 50° C. for 10 minutes but the stirring is increased (position 3). The Thermomix is then set to 90° C., and once this temperature is reached, it is maintained for 30 seconds (Thermomix in position 1). The mixture is then directly molded and placed in a cold room at 4° C., After 4 hours of gelling, the product is demolded and then cut into cylindrical pellets of 18 mm diameter and 12 mm in height that are directly inserted in a dehydrator Ultra FD 1000 brand Ezi Dri (company BestBay Pty Ltd, Australia) of which the temperature setpoint is set at 30° C., to adjust their moisture to 20% (drying time of about 18 hours), The main feature advantageously obtained resides in obtaining a very firm and elastic gel and thus easily convertible into pellets to the desired dimensions. The dried pellets are placed in a microwave oven at a power of 750 W for 45 seconds. The volume obtained after passing the microwave treatment is on average 250% compared to the initial volume [(volume after baking)/(volume before baking)*100%)]. The product is characterized by a preserved form (shape after drying is similar to that after curing) a fine, a crispy, crunchy texture and a relatively neutral taste.

### EXAMPLE 2

The methodology of Example 1 is repeated, except that the milk proteins are replaced by soya proteins in the form of the protein isolate DENA SOY Protei S 90 C (supplier: Solina Group). The texturing additive used is precipitated calcium sulphate (purity 99.9%). For this mixture, 27.30 g of standard anhydrous milkfat (supplier: Corman, Belgium) were melted in 450 ml of spring water. Then a mixture of 75.45 g of soy protein and 1 g of calcium sulfate is added with stirring, following the same method as for Example 1. For this test, the temperature of 90° C. is maintained for 15 minutes to give a gel by heat coagulation. The base obtained is easily cut and does not spread owing to its firmness. The resulting expansion after the microwave treatment is greater than 300% [volume after curing)/(volume before curing)*100%>]. The product obtained is darker in color (due to soy protein), very convoluted and crispy.

### EXAMPLE 3

In a mixer-cooker-emulsifier, jacketed for heating and cooling, and with direct steam injection having a volume of 24 liters, marketed by the department Stephan of the company Sympak Process Engineering GmbH (Schwarzenbek, Germany) are introduced 1950 g of anhydrous milkfat, 8475 g of water, 2550 g of milk protein isolate (protein content 86% by weight compared to the dry matter) sold by the company Ingrédia (Arras, France) under the reference Promilk SH20 1500 g of Camembert powder (reference 10034 Dairygold food Ingredients Ltd., Ireland), and 75 g of Gouda flavor (reference RD60A25204 Dairygold Food Ingredients Ltd., Ireland). This mixture is homogenized and emulsified (emulsion of oily globules suspended in water, and colloidal suspension of caseins in the aqueous phase) at the temperature of 50° C. for a period of 10 minutes. Throughout the duration of the homogenization process, the device is placed under vacuum (0.5 bar) in order to deaerate the substantially homogeneous mixture obtained. The deaerated homogeneous mixture is then subjected, in the same equipment, to a heat treatment at a temperature of 80° C. for a period of 30 seconds, then is cooled to a temperature of 45° C. At this temperature and always in the same equipment, are then added 225 g of the food additive E575 (Gluconolactone marketed by Acros), and 1.65 ml of chymosin produced by fermentation, marketed by Chr. Hansen (Arpajon, France) under the name Chy-Max. After mixing at 600 rounds/minute, the mixture (having a total weight of 14,8 kg) is withdrawn from the Stephan mixer and poured into rectangular molds of 1 liter capacity each. Coagulation-acidification is allowed to occur in the molds for 24 hours at a temperature of 20° C. The pH, measured at the end of this step, is 5.5. At the end of this time, the content of each mold is sliced into thin slices and then subjected to pre-drying in a ventilated oven at 35° C. for 10 hours, until a water content of 30% by weight in the coagulated mixture pre-dried is reached. The product is cooled to 10° C. in order to increase its firmness and is then grated into fine strands (longitudinal dimension 10-20 mm, transverse dimension 1-2 mm) using a Handmark Machine before submitting the grated pre-dried mixture to atmospheric pressure expansion of treatment in a microwave oven (750 W power, duration 90 seconds, at a frequency of 2.45 GHz), in silicone molds. After unmolding, 7.13 kg of a crusty expanded dry food product of cheese type with Gouda flavor is obtained, with a measured residual water content of 5.0 wt %. The composition by weight of this product is approximately as follows: 61% milk protein, 29,3% milk fat, 3,38% gluconate, traces of rennet, 1,13% flavoring agent, and 5,17% of water.

For the preservation of its taste and organoleptic properties, it is recommended to package and store the product in a dry area with controlled humidity.

From a nutritional standpoint, 100 g of the product correspond to an energy intake of 565 kcal.

### EXAMPLE 4

The procedure of example 3 is repeated, but in a mixer-cooker-emulsifier having a volume of 5 liters and from the following amounts of ingredients: 1102 g of water, 135 g of anhydrous milk fat, 225 g of milk protein isolate (85.5% protein content by weight in the dry matter) sold by the company Ingrédia (Arras, France) under the name Promilk 852A, 15 g of the food additive E575 (gluconolactone marketed by Acros), 0.16 ml of chymosin produced by fermentation, marketed by Chr. Hansen (Arpajon, France) under the name Chy-Max, and 23 g of a plant hydrocolloidaltexturizing agent in powder (instead of starch of Example 1) sold under the name Sosa and comprising alginate, carrageenan, and carob and xanthan gums. After adding chymosin and E575, the product is stored in a cold room at 5° C. for 4 hours until a pH of about 5.0 is reached. The resulting block is then portioned into cylinders 18 mm in diameter and 12 mm height, which are pre-dried to achieve a moisture content of 18% by weight and then subjected to a microwave treatment (power 850 W) for 30 seconds at atmospheric pressure. After unmolding, 427 g of a crispy expanded dry food product, of cheese type, is obtained, with a measured residual water content of 6.9% by weight. The composition by weight of this product is approximately as follows: 52.6% milk protein, 31.9% of milk fat, 3.27% hydrocolloid texturing food grade 3.5% gluconate, the traces of rennet, and 6.9% of water.

### EXAMPLE 5

The method of example 3 is repeated, decreasing the amount of chymosin to 0.36 ml but retaining the amounts of the other ingredients. The slicing capacity of the product before pre-drying and grating is not affected, and expansion characteristics, crispness and taste of the final product are identical to those of Example 1.

EXAMPLE 6

The method of example 3 is repeated but replacing the milk protein Promilk SH20 by the same amount of milk protein Promilk 852A (Ingrédia provider, Arras, France). The product slicing capacity before pre-drying and buffing is not affected. The expansion characteristics and taste of the final product are identical to those of Example 1, but its crispness is slightly lower.

### EXAMPLE 7

The procedure of example 3 is repeated but replacing 2550 g of milk protein isolate Promilk SH20 by a mixture of 2295 g of Promilk SH20 and 255 g of insoluble fibers sold by the company Cosucra (Pecq, Belgium) under the name Fibruline. The slicing capacity of the product before pre-drying and grating is not affected, and expansion characteristics, crispness and taste of the final product are identical to those of Example 1, but due to its content of about 3.5% fiber, the obtained expanded product benefits from the nutrition claim “source of fiber”.

### EXAMPLE 8

The procedure of example 3, adding 60 g of alginate sold by Cargill (Minneapolis, USA) under the reference S550, or by 60 g of carrageenan sold under the reference 5311 by MCH Carragel Gelymar company (Santiago, Chile), or by 22.5 g locust bean gum Viscogum Be (marketed by Cargill (Minneapolis, USA), or by 22.5 g of xanthan gum XGT FN marketed by Jungbunzlauer company (Pernhofen, Austria). The characteristics of expansion, crispness and flavor of the final product are substantially identical to those of example 1. This demonstrates the beneficial role of a range of hydrocolloids texturing agents.

### EXAMPLE 9

In a mixer-cooker-emulsifying mixer with knife, having a volume of 5 liters, jacketed for heating and cooling, marketed by Stephan department of the company Sympak Process Engineering GmbH (Schwarzenbek, Germany), were introduced in 1140 ml source of water which was heated to 70° C. with gentle stirring. Then, a powder mixture containing 300 g of milk protein isolate (protein content 86% by weight relative to dry matter) marketed by the company Ingrédia (Arras, France) under reference Promilk SH20 (same as used in example 3) and 22.5 g of a powdered hydrocolloid texturing vegetable agent sold under the name Sosa and comprising carrageenan and locust bean gum (the same as used in example 4) is incorporated under low stirring (300 rpm). The mixture is maintained at 70° C. for 20 minutes under the same stirring. It is then cooled, still with stirring, to 45° C. to incorporate 15 g of the food additive E575 (Gluconolactone sold by Acros) and after 30 seconds, 0.20 ml of chymosin produced by fermentation, marketed by Chr. Hansen (Arpajon, France) under the name Chy-Max.

The mixture was then transferred directly into a container and stored at room temperature (about 20° C.) for 4 hours and then placed in a refrigerated room at 4° C. After 24 hours, the product is removed from the mold and cut into cubes of 14 mm that are directly inserted into a dehydrator Ultra FD 1000 of the Ezidri brand (company BestBay Pty Ltd, Australia) whose temperature setpoint is set to 30° C., in order to adjust their moisture to 16% (drying time of about 18 hours). The dried pellets are put in a fridge at 4° C. for 24 hours. The pellets were then placed in a microwave oven with a power of 1800 W for 28 seconds. The volume obtained after passing the microwave oven is on average 280%) relative to the initial volume [(volume after curing)/(volume before curing)*100%]. The resulting product is crunchy and crispy and has a neutral taste with a measured water content of 10.2% by weight.

1. Expanded dry food product comprising at least the following ingredients:
a protein concentrate of animal or vegetable origin, food-grade,
a food-grade texturizing additive selected from the group consisting of hydrocolloids and vegetable gelling agents, proteolytic additives and their hydrolysis products, and the acidifying agents and their salts thereof, and
residual water.

2. Food product according to claim 1, being free of fat food grade. other than an impurity of the protein concentrate of animal or vegetable origin, food-grade.

3. Food product according to claim 1, wherein there is provided from 65% to 95% by weight of the protein of the protein concentrate of animal or vegetable origin.

4. Food product according to claim 1, characterized in that it comprises from 0.2% to 10% by weight of the food-grade texturizing additive.

5. Food product according to claim 1, characterized in that it comprises a food grade salt derivative of an acidifying agent, other than a citrate or phosphate.

6. Food product according to claim 5, characterized in that it comprises from 0.2 to 6% by weight of food-grade salt derivative of an acidifying agent.

7. Food product according to claim 1, characterized in that it comprises a proteolytic additive or its hydrolysis product.

8. Food product according to claim 7, wherein the proteolytic additive is a specific protease of the protein present in the concentrate of animal or vegetable origin, or a hydrolysis product thereof.

9. Expanded dry food product according to claim 7, wherein the proteolytic additive is an enzyme of animal, plant or microbial origin, or a hydrolysis product thereof.

10. Expanded dry food product according to claim 7, wherein the food-grade animal protein concentrate is a concentrate of milk protein, and the proteolytic additive is rennet or a protease such as chymosin.

11. Food product according to claim 1, wherein the residual water content is at least 3% by weight and less than 12% by weight.

12. A thermally expandable precursor capable of forming an expanded dry food product according to claim 1, comprising at least the following ingredients:
a protein concentrate of animal or vegetable origin, food-grade,
a food-grade texturizing additive selected from the group consisting of hydrocolloids and vegetable gelling agents, proteolytic additives and their hydrolysis products, and the acidifying agents and their salts thereof, and
water.

13. A thermally expandable precursor according to claim 12, wherein there is provided from 65% to 85% o by weight of water.

14. A method for preparing a thermally expandable precursor according to claim 13, comprising the steps of:
combining, at a temperature between 4° C. and 75° C. the concentrated protein of animal or vegetable origin, the food-grade texturizing additive and water, and
where appropriate, adding an acidifying agent or one of its food acceptable salts, and/or a proteolytic additive or a hydrolysis product thereof.

15. The method of manufacturing an expanded dry food product of claim 14, further comprising the step of subjecting the thermally expandable precursor to heat to cause its expansion and the reduction of the water content to the residual content, wherein the expanded dry food product comprises at least the following ingredients:
a protein concentrate of animal or vegetable origin, food-grade,
a food-grade texturizing additive selected from the group consisting of hydrocolloids and vegetable gelling agents, proteolytic additives and their hydrolysis products, and the acidifying agents and their salts thereof and
residual water.
